(19) United States
(12) Patent Application Publication
(10) Pub. No.: US 2008/0162306 A1
(43) Pub. Date: Jul. 3, 2008

(54) SYSTEMS AND METHODS FOR PERFORMING PRIORITY RESERVATIONS AND TRANSACTIONS

(76) Inventors: C. Lloyd Mahaffey, Eagle, ID (US); John Johnston, Eagle, ID (US); Erik Oaas, Boise, ID (US); Steve Laney, Boise, ID (US); Steve Inch, Boise, ID (US)

Correspondence Address: PERKINS COIE LLP;PATENT-SEA, P.O. BOX 1247, SEATTLE, WA, 98111-1247, US

(21) Appl. No.: 11/952,978

(22) Filed: Dec. 7, 2007

Related U.S. Application Data
(60) Provisional application No. 60/869,108, filed on Dec. 7, 2006.

(51) Int. Cl. G06Q 30/00; G06F 17/30; G06Q 20/00

(52) U.S. Cl. 705/27; 707/104.1; 705/39; 707/E17.009

(57) ABSTRACT

A reservation system for performing priority reservations and transactions, such as real estate reservations and transactions. In one embodiment, the reservation system can receive a reservation request from a potential buyer for reserving a next available priority number on an interest list. In some embodiments, the reservation system can create a reservation account and receive deposit funds in the reservation account. In other embodiments, the potential buyer is linked to and provided with a unique PIN. A real-time priority number can be made available upon receiving a real-time priority request, wherein the real-time priority request comprises the PIN.

### CROSS-REFERENCE TO APPLICATION(S) INCORPORATED BY REFERENCE

The present application claims priority to U.S. Provisional Patent Application No. 60/869,108 filed Dec. 7, 2006, entitled “SYSTEMS AND METHODS FOR REAL ESTATE RESERVATIONS AND TRANSACTIONS,” and incorporated herein in its entirety by reference.

### TECHNICAL FIELD

The following disclosure relates generally to systems and methods for reserving real estate and/or other types of property and/or conducting other transactions relating to real estate.

### BACKGROUND

Real estate developers typically release home sites, new construction homes and/or other purchasable property units, such as condominiums, vacation homes, vacation time-shares, etc. in phases or groupings. Advertising and marketing of pre-released properties will typically occur prior to availability of these properties for purchase and sale. Accordingly, buyers interested in purchasing a future real estate property unit may wish to ensure that they receive a priority consideration or option to purchase when the properties become available for sale. Developers may be interested in tracking information regarding demand and interest in future sales as well as track information about potentially interested buyers that can translate into targeting marketing strategies for recruiting additional interested buyers.

Computers have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g. PDA's). All of these protocols provide easier ways to provide information to people via various data processing devices. Many other protocols and means for exchanging data between data processing devices continue to develop to further aid the exchange of information.

In today's market, the internet is becoming a preferred mode for people to search and shop for real estate property. A potential buyer will typically do property searches in targeted geographical areas or according to preferred amenities, etc. In some cases, potential buyers shop for property in one or more geographical locations remote from their current location. Web pages depicting real estate property and purchasing information, including pictures, acreage, square footage, and other similar information are numerous and include a main generator of buyer interest for real estate agents and real estate developers.

### BRIEF DESCRIPTION OF THE DRAWINGS

FIG. 1 is a block diagram of a basic and suitable computer that may employ aspects of the disclosure.

FIG. 2A is a block diagram illustrating a simple, yet suitable system in which aspects of the disclosure may operate in a networked computer environment.

FIG. 2B is a block diagram illustrating an alternative system to that of FIG. 2A.

FIG. 3 is a schematic block diagram illustrating a reservation system providing priority reservations and associated transactions in accordance with an embodiment of the disclosure.

FIGS. 4A-4B are flow diagrams of routines for performing an online priority reservation in accordance with embodiments of the disclosure.

FIGS. 5A-5B are flow diagrams of routines for performing an online real estate priority reservation in accordance with embodiments of the disclosure.

FIG. 6 is a schematic diagram of a screen display configured in accordance with an embodiment of the disclosure.

FIG. 7 is a schematic diagram of a display page that includes information relating to confirming registration in accordance with an embodiment of the disclosure.

FIG. 8 illustrates a payment display page whereby the potential buyer can provide payment information in accordance with an embodiment of the disclosure.

FIG. 9 is a schematic diagram of a display page having an interactive map for selecting and reserving a specific real estate asset in accordance with an embodiment of the disclosure.

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

The headings provided herein are for convenience and do not necessarily affect the scope or interpretation of the disclosure.

### DETAILED DESCRIPTION

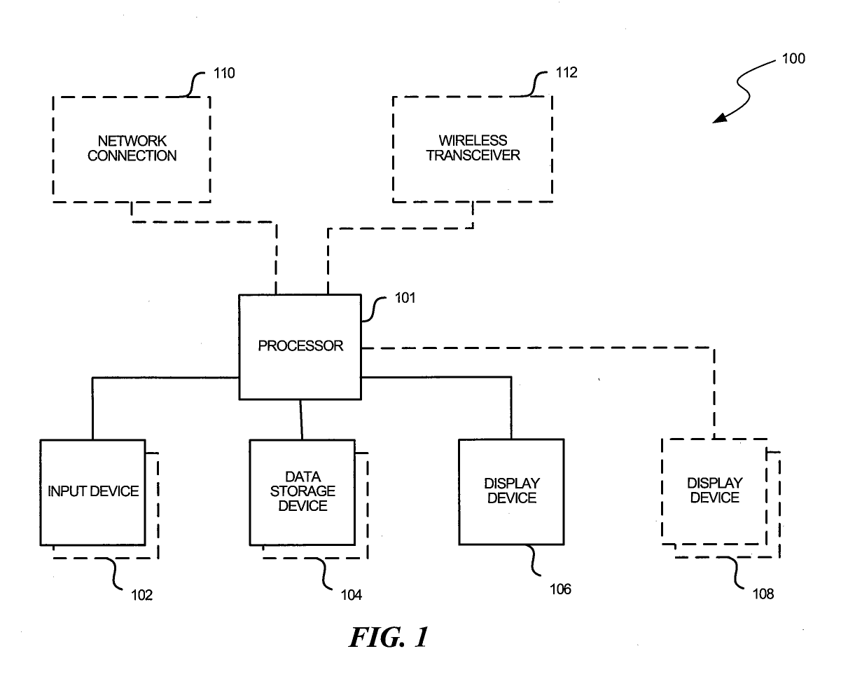

Various embodiments of the present disclosure are directed to computer-implemented methods and systems for reserving a purchase option on real estate (e.g., a new home), and/or for conducting other transactions related to real estate and/or other property. In at least one embodiment of the present disclosure a person wishing to reserve a purchase option on a new home or land plot in, e.g., a planned development, can do so remotely using a suitable computing device, such as a networked computing device. These and other features of various embodiments of the disclosure are explained in greater detail below and in related FIGS. 1-5C.

The following description provides specific details for a thorough understanding and enabling description of these embodiments. One skilled in the art will understand, however, that the disclosure may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

A. Suitable Computing Environments in which Aspects of the Disclosure can be Implemented

FIG. 1 and the following discussion provide a brief, general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The disclosure can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the disclosure may reside on a server computer, while corresponding portions reside on a client computer. Data structures and transmission of data particular to aspects of the disclosure are also encompassed within the scope of the disclosure.

Referring to FIG. 1, one embodiment of the disclosure employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

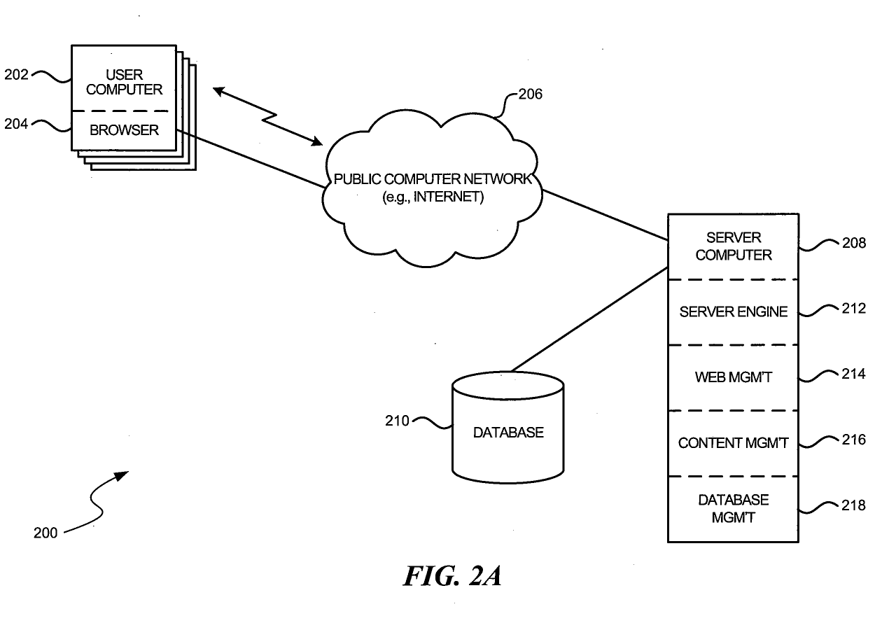

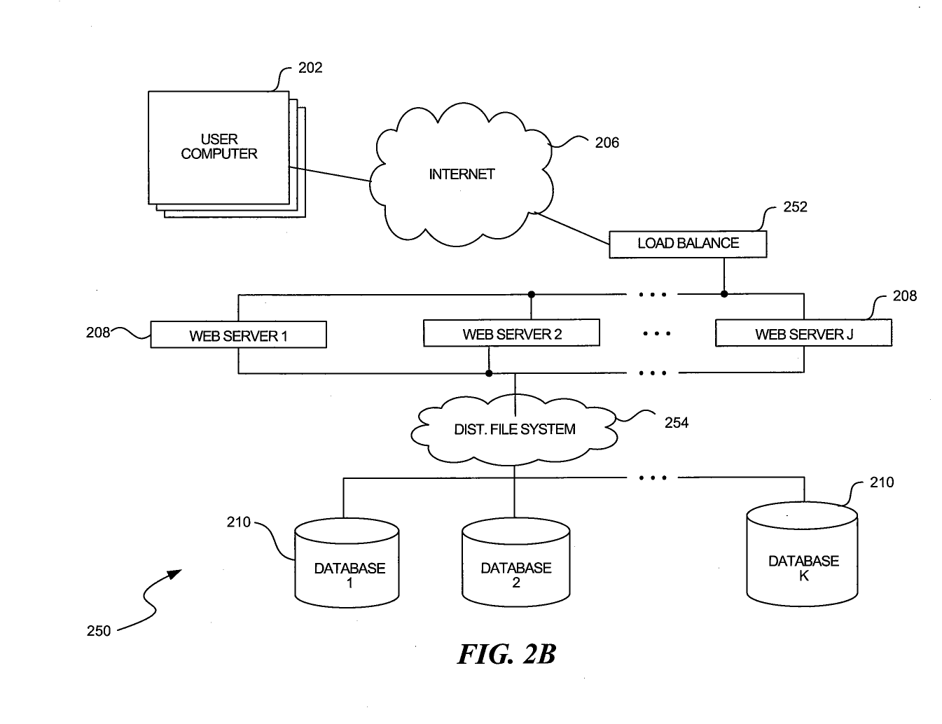

Aspects of the disclosure may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Referring to FIG. 2B, an alternative embodiment to the system 200 is shown as a system 250. The system 250 is substantially similar to the system 200, but includes more than one server computer (shown as server computers 1, 2, . . . J). A load balancing system 252 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

Many of the functional units described herein have been labeled as modules, in order to more particularly emphasize their implementation independence. For example, modules may be implemented in software for execution by various types of processors, such as processor 101. An identified module of executable code may, for instance, comprise one or more physical or logical blocks of computer instructions which may, for instance, be organized as an object, procedure, or function. The identified blocks of computer instructions need not be physically located together, but may comprise disparate instructions stored in different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### B. Embodiments of Methods and Systems for Priority Reservations and Transactions

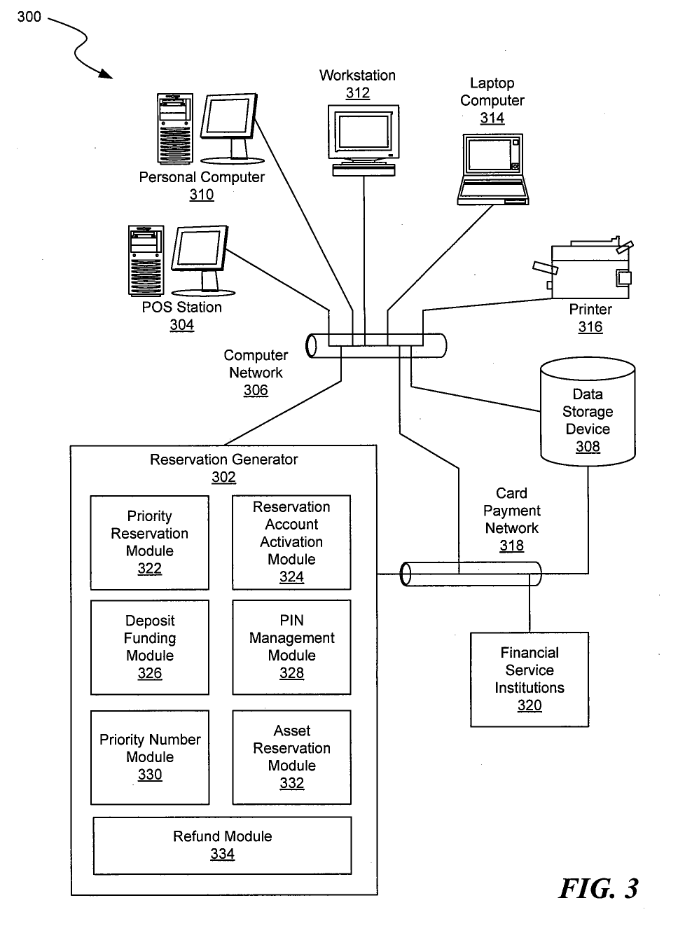

FIG. 3 depicts a system 300 for providing priority reservations and associated transactions in accordance with an embodiment of the disclosure. Use of the system 300 can substantially automate a reservation process and while increasing the convenience of maintaining and monitoring a priority-based interest list. The system 300 includes a reservation generator 302, which can reside on a server such as server 208, in communication with client computers, such as personal computer 310, workstation 312, laptop computer 314, point-of-sale (POS) station 304, etc. (“client computer”), through a computer network 306. The computer network 306 can be substantially similar in structure and function to computer network 206. The reservation generator 302 can be in communication with a data storage device 308. The system 300 can also include a printer 316, and/or other devices in communication with the reservation generator 302 through the computer network 306.

The reservation generator 302 is capable of communicating a financial transaction through the computer network 306 to a card payment network 318 for credit approval, transfer of funds and other transaction-related communications. Electronic payment transactions from Internet websites or webpages (or other types of eCommerce systems) that conduct remote transactions in which a physical card is not presented to the reservation generator 302, are supported by the system 300. Mobile interfaces (e.g., cell phones) to mobile commerce applications, that conduct a mix of physical card and remote transactions, can provide portals for electronic payment transactions that can be implemented by the system 300. In some embodiments, users of the system 300 can also communicate and permit financial transactions using the telephone. In these situations, an account number associated with the card is typically used to complete the transaction. One of ordinary skill in the art will recognize that the reservation generator 302 and the networks 306 and 318, can include other add-on systems arranged in other ways without departing from the spirit or scope of the present disclosure.

In one embodiment, the reservation generator 302 can be associated directly with a provider of reservations and/or assets for purchase. For example, if the priority reservation is for a next available priority number in a real estate interest list, the reservation generator 302 can be associated with a real estate provider or manager (e.g., real estate broker, real estate agent, real estate developer, Title Company, etc.). The reservation generator 302 can be in direct communication with the card payment network 318, which is operatively connected to financial service institutions 320 for authorization and capture of reservation deposits and other transaction payments. In another embodiment, the computer network 306 can be in direct communication with the payment card network 318.

In one embodiment, the reservation generator 302 can include a priority reservation module 322, a reservation account activation module 324, a deposit funding module 326, a PIN management module 328 and a priority number module 330. In other embodiments, the reservation module 302 can also include one or more additional modules, such as an asset reservation module 332 and a refund module 334, all of which will be described in detail below. The account activation module 322 can be included for allowing a user to activate a new merchant-specific account and link that account to an existing instrument/card. The priority reservation module 322 can be configured to receive a reservation request form a client computer for reserving a next available priority number in an interest list. In one example, the next available priority number is a real-time priority number that can change according to changes to the number and position of potential buyers on the interest list.

The interest list can be a list of potential buyers interested in purchasing and/or acquiring an asset. In one embodiment, the asset can be a real estate asset. In one aspect of this embodiment, the real estate assets may not be presently for sale. For example, the interest list may be a real estate interest list maintained by a real estate developer prior to release for sale of home sites, houses, condominiums, etc. In another embodiment, the interest list could be a list of interested purchasers of other limited or varying commodities, such as vacation rentals, time-share units, travel arrangements such as flights, cruises or guided tours. One of ordinary skill in the art will recognize other types of interest lists for which a potential buyer would wish to secure a priority reservation for maintaining a first-come-first serve priority option to purchase the asset.

The priority reservation module 322 can also be configured to receive identification information provided by a potential buyer. In some embodiments, the priority reservation module 322 can also receive interest preference information that a potential buyer may provide during the reservation process. For example, the potential buyer may include preference information related to asset type, quantity, price, etc. relating to the asset(s) of interest and/or for which the interest list is intended. Information received by the priority reservation module 322 can be stored on a database, such as the data storage device 308, configured to store reservation related data. In some embodiments, the priority reservation module 322 can also be configured to provide reservation instructions to the potential buyer. Furthermore, the priority reservation module 322 can be configured to provide information relating to terms and conditions of a reservation agreement, and in some embodiments, receive acceptance from the potential buyer of the terms and conditions.

In one embodiment, the reservation account activation module 324 can be configured to create a reservation account and to receive funds in the reservation account. In a specific example, for a potential buyer requesting to reserve a real-time priority number on a real estate interest list, the reservation account activation module 324 can create a real estate reservation account for receiving a real estate reservation deposit or other similar priority fee. The deposit funding module 326 can be configured to receive from the client computer information for a buyer-owned financial account and receive permission from the client computer to debit the buyer-owned financial account. The deposit funding module 326 can also be configured to communicate with the financial institution processor at a financial service institution 320 (e.g., bank, credit card company, mortgage lender, etc.), wherein the communication includes requesting a transfer of funds from the buyer-owned account to the reservation account. For example, the deposit funding module 326 can communicate with one or more financial institution processors of the financial service institutions 320 via the card payment network 318.

The deposit funding module 326 can initiate authorization commands for requesting a transfer of deposit funds from the buyer-owned financial account to the recently created reservation account. Capture of these deposit funds by the deposit funding module 326 corresponds to a deposit of units of value in a potential buyer's new reservation account. In one embodiment, the reservation account can be held at financial generator-associated financial institution. In another embodiment, the reservation account can be held by an escrow company. One of ordinary skill in the art will recognize a variety of methods for requesting and receiving transfer of funds and a plurality of financial institutions capable of holding and/or managing the reservation accounts.

The reservation generator 302 can also include a personal identification number (PIN) management module 328 configured to execute one or more routines for linking a unique PIN to a potential buyer. In some embodiments, the PIN can be linked to a potential buyer's identification information and/or the PIN can be linked to a potential buyer's reservation account. The PIN management module 328 can also be configured to manage PIN-access to potential buyer identification information, a potential buyer's reservation account, a potential buyer's real-time priority number on the interest list, etc, by a potential buyer, an interest list provider, or other entity having access to the PIN. In one embodiment, the PIN management module 328 can be configured to generate the unique PIN prior to link to the potential buyer. In another embodiment, the PIN management module 328 can be configured to prompt and/or accept a potential buyer-selectable PIN to link to the potential buyer.

The priority number module 330 can be configured to make available a priority number responsive to receipt of a valid PIN. For example, the priority number can be a real-time and/or dynamic number that can be changed for each individual potential buyer according to changes in the interest list. Accordingly, the priority number module 330 can report a real-time priority number to a potential buyer or other entity having access to the PIN when requested. In a specific example, if a potential buyer has reserved a real-time priority number on an interest list, an initial priority number reported by the priority number module 330 upon query, may be 10. If a second potential buyer, having a priority number of 9, elects to remove himself/herself from the interest list, the real-time priority number reported to the potential buyer (in a later, second query) can be a priority number 9.

In another embodiment, the reservation generator may not include the PIN management module 328. In this embodiment, the priority number module 330 can be configured to provide a priority number to the potential provider. In this embodiment, the potential buyer receives the next available priority number on the interest list and, in one embodiment, the priority number can be linked to the potential buyer, In some embodiments, if a potential buyer's priority number changes, the potential buyer can be notified by the priority number module of his/her new priority number.

The reservation generator 302 can also include the asset reservation module 332 that can be configured to activate a PIN-responsive priority number and to receive a request from the client computer to reserve a specific asset selected form one or more available assets. The asset reservation module 332 can also be configured to provide selections of available assets from which the potential buyer may choose to reserve and/or purchase (e.g., enter into a purchase and sale agreement). In other embodiments, the PIN can be the potential buyers' priority number.

In one embodiment, the asset reservation module 332 can be configured to provide notification to a first potential buyer when the real-time priority currently retrieved by the first potential buyer's PIN is higher (i.e. wherein a higher priority can include a lower numerical number on the interest list) than all other priorities reserved on the interest list. Accordingly, the asset reservation module 332 can be configured to notify a second potential buyer having a second highest real-time priority currently retrieved by the second potential buyer's PIN after an elapsed period of time from the notification to the first potential buyer.

As described in greater detail below, the reservation system 300 can enable potential buyers to reserve a priority option to purchase assets of interest on a first-come-first-serve basis, while efficiently monitoring their priority status on the interest list. The reservation generator 302 can also provide a payment gateway capable of handling reservation priorities, deposit transactions and asset reservations without the need for manual input by an interest list manager.

By incorporating the functionality of the reservation generator 302 into existing reservation systems, product and/or real estate developers and associated business parties can enable profitable simple models for potential buyers to reserve a priority option to purchase a desirable asset, such as real estate assets. In addition, asset providers and developers can track product/asset interest via the interest list the cumbersome and time-involved complexities of conventional systems and interest lists. Moreover, in the example of real estate developments and interest lists, potential buyers need not be geographically present to reserve a priority option to purchase a real estate asset or to reserve and/or purchase a real estate asset. Accordingly, these types of transactions can be performed from a remote location.

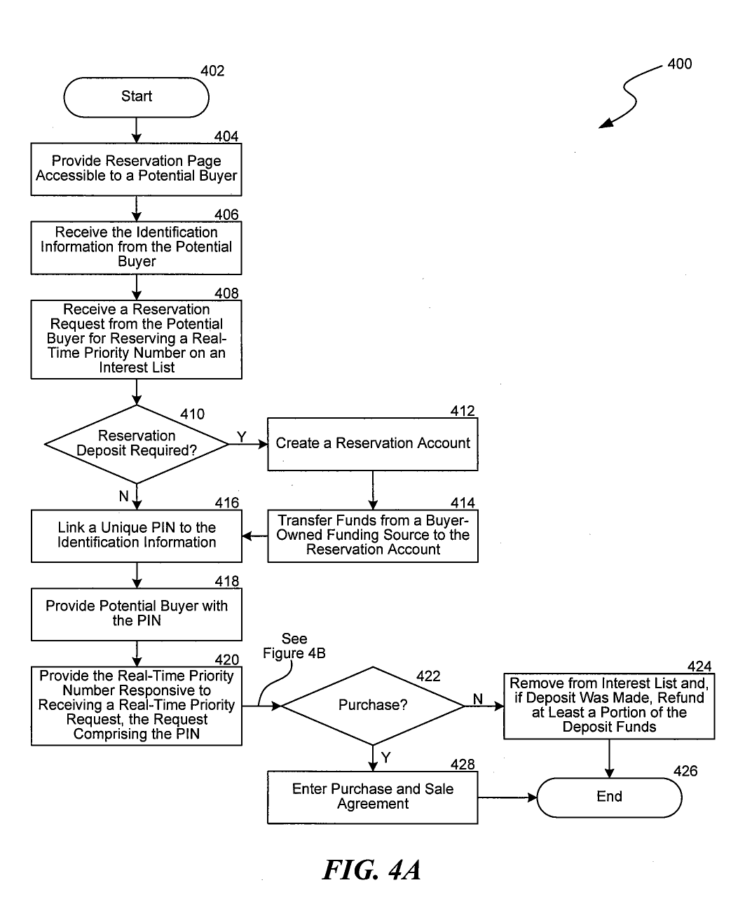

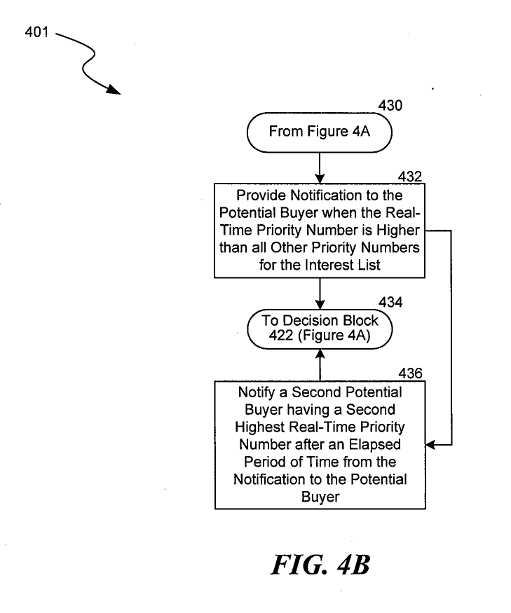

FIG. 4A is flow diagram of a routine 400 for performing a reservation, such as an online reservation, in accordance with an embodiment of the disclosure. In one aspect of this embodiment, the routine 400 can be at least partially performed by a person wishing to reserve a real time priority number on an interest list, such as a potential buyer of an asset. In one embodiment, the asset can be presently unavailable for sale such that a potential buyer can reserve their option to purchase the asset in a first-come-first served basis when/if the asset becomes available for sale. In another embodiment, the asset can be presently for sale. The potential buyer can perform the routine 400 with a user and/or client computer (e.g., the user computer 202 of FIG. 2A). In other embodiments, the routine 400 can be performed by other entities using other networked and non-networked devices for performing a reservation.

The routine 400 begins 402 and a reservation page is provided and is accessible to a potential buyer (block 404). For example, the reservation page can be a web page accessible via the internet. The priority reservation module 322 receives identification information from the potential buyer (block 406) and receives a reservation request from the potential buyer for reserving a real-time priority number on an interest list (block 408). If a reservation deposit is required to acquire a reservation (block 410), the reservation account activation module 324 creates a reservation account (block 412). Before creating the reservation account in the step in block 412, the reservation account activation module 324 can provide terms and conditions of a reservation agreement and receive a potential buyer's agreement to the terms and conditions of the agreement.

The deposit funding module 326 transfers funds from a buyer-owned funding source to the reservation account (block 414). For example, the deposit funding module 326 can receive information for a buyer-owned financial account and receive permission from the potential buyer to debit the buyer-owned financial account during the step in block 408. The debit funding module 326 can also communicate with a financial service institution processor and request a transfer of funds from the buyer-owned account to a the reservation account. In block 416, the PIN management module 328 links a unique PIN to the identification information and/or the reservation account. Following the linking step, the PIN management module 328 provides the potential buyer with the PIN (block 418). The priority number module 330 provides the real-time priority number responsive to receiving a real-time priority request (block 420), wherein the real-time priority request comprises a PIN.

Following reservation for a real-time priority number on an interest list, the opportunity may be presented to purchase an asset of interest (block 422). If the potential buyer does not wish to exercise their priority option to purchase the asset, the potential buyer can be removed from the interest list (block 424). If a reservation account was created (block 412) and a reservation deposit was made in the reservation account (block 414), the refund module 334 refunds at least a portion of the deposit funds (block 424). In one embodiment, the at least a portion of the deposit funds can be returned to the buyer-owned funding source. Following refund in block 424, the routine 400 can end 426. In another embodiment, a potential buyer may not wish to presently exercise their priority option to purchase the asset; however, they can reserve their priority option to purchase at a future time by updating their real-time priority number to the lowest priority number on the interest list. In the event that the potential buyer decides (block 422) to exercise their priority option to purchase the asset, the potential buyer can enter a purchase and sale agreement (block 428). In one embodiment, the reservation deposit can be applied to the purchase price of the asset. Following entry into a purchase and sale agreement in block 428, the routine 400 can end 426. One of ordinary skill in the art will recognize that the routine 400 can also end 426 following blocks 418 or 420.

FIG. 4B is flow diagram of a routine 401 for providing notification to a potential buyer of an opportunity to purchase and/or reserve a specific asset in accordance with an embodiment of the disclosure. The routine 401 begins 430 following block 420 in routine 400. The asset reservation module 332 provides notification to the potential buyer when the real-time priority number is higher than all other priority numbers for the interest list (block 432). Following notification in block 432, the routine 401 returns 434 to decision block 422 in routine 400 (FIG. 4A). Also, following block 432, the routine 401 continues in block 436 wherein the asset reservation module 332 notifies a second potential buyer having a second highest real-time priority number after an elapsed period of time from the notification to the potential buyer in block 432. Following notification in block 436, the routine 401 returns 434 to decision block 422 in routine 400 (FIG. 4A).

In one embodiment, the elapsed period of time can be approximately 1 minute to several days (e.g., about 1 day to about 10 days). In another embodiment, the second potential buyer with the second highest real-time priority number can be notified (block 436) after the potential buyer has finalized a selection enabled by the notification. One of ordinary skill in the art will recognize additional time periods and time delays to separate blocks 432 and 436.

As described above, the PIN number is linked to at least the identification information and is a static identifier of the potential buyer. After receiving a first real-time priority number upon completion of the reservation routine 400, for example, the real-time priority number may change in real-time as potential buyer's having a higher priority number opt to remove themselves from the interest list. An advantage of the current system and routine is that the PIN enables a simplified manner in which the potential buyer can determine their priority registration number on the interest list at any point in time, regardless of the changes being made to the list via the removal other priority number holders. Furthermore, the present disclosure provides a simplified system for interest list managers because a priority number is not statically associated with a particular potential buyer, which can create confusion when the list is changed and/or updated. One of ordinary skill in the art will recognize that the routines 400 and 401 can be performed by other modules and/or combinations of modules.

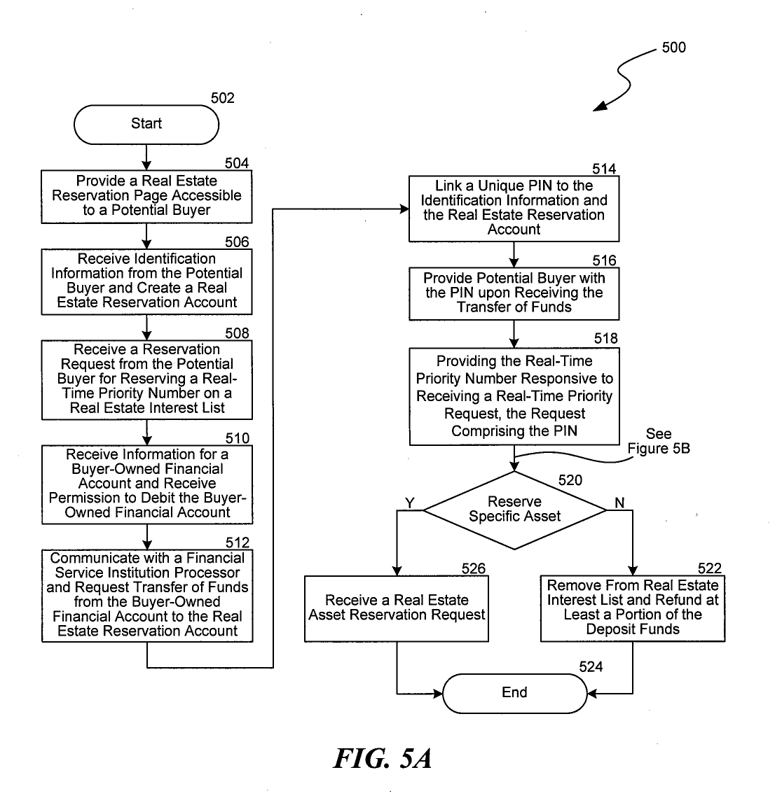

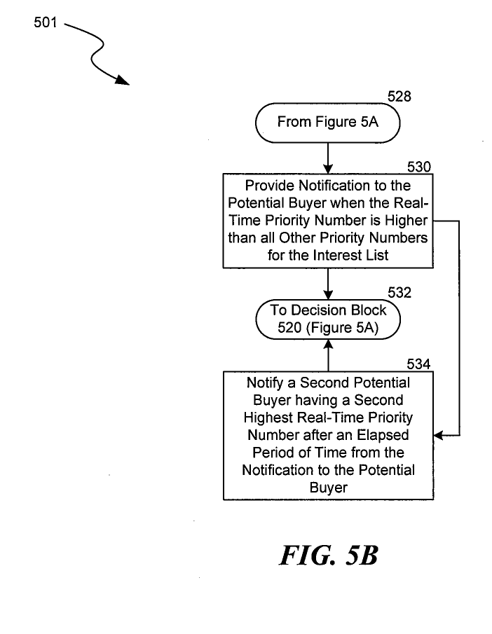

FIG. 5A is a flow diagram of a routine 500 for performing a real estate reservation in accordance with an embodiment of the disclosure. In one aspect of this embodiment, the routine 500 can be at least partially performed by a person wishing to reserve a real time priority number on a real estate interest list, such as a potential buyer of a real estate asset. In one embodiment, the real estate asset can be presently unavailable for sale such that a potential buyer can reserve their option to purchase the real estate asset on a first-come-first served basis when/if the real estate asset becomes available for sale. In another embodiment, the real estate asset can be presently for sale. The potential buyer can perform the routine 500 with a user and/or client computer (e.g., the user computer 202 of FIG. 2A). In other embodiments, the routine 500 can be performed by other entities using other networked and non-networked devices for performing a reservation.

The routine 500 begins 502 and a real estate reservation page is provided and is accessible to a potential buyer (block 504). For example, the real estate reservation page can be a web page accessible via the internet. The priority reservation module 322 receives identification information from the potential buyer (block 506) and receives a reservation request from the potential buyer for reserving a real-time priority number on a real estate interest list (block 508). The reservation account activation module 324 creates a reservation account (block 508). Before creating the reservation account in the step in block 508, the reservation account activation module 324 can provide terms and conditions of a reservation agreement and receive a potential buyer's agreement to the terms and conditions of the agreement.

The deposit funding module 326 receives information for a buyer-owned financial account and receives permission to debit the buyer-owned financial account (block 510). Following block 510, the deposit funding module 326 communicates with a financial service institution processor and requests transfer of funds from the buyer-owned financial account to the real estate reservation account (block 512). In block 514, the PIN management module 328 links a unique PIN to the identification information and the real estate reservation account. Following the linking step in block 514, the PIN management module 328 provides the potential buyer with the PIN upon receiving the transfer of funds (block 516). The priority number module 330 provides the real-time priority number responsive to receiving a real-time priority request (block 518), wherein the real-time priority request comprises a PIN.

Following reservation for a real-time priority number on a real estate interest list, the opportunity may be presented to reserve a specific real estate asset for purchase (decision block 520). If the potential buyer does not wish to exercise their priority option to reserve a specific real estate asset for purchase, the potential buyer can be removed from the real estate interest list and the refund module 334 refunds at least a portion of the deposit funds (block 522). In one embodiment, the at least a portion of the deposit funds can be returned to the buyer-owned financial account. Following refund in block 522, the routine 500 can end 524. In another embodiment, a potential buyer may not wish to presently exercise their priority option to reserve a specific real estate asset for purchase, however, they can reserve their priority option to purchase at a future time by updating their real-time priority number to the lowest priority number on the real estate interest list.

In the event that the potential buyer decides (block 520) to exercise their priority option to reserve a specific real estate asset for purchase, the asset reservation module 332 can receive a real estate asset reservation request (block 526), wherein the real estate asset reservation request includes a valid PIN and a specific real estate asset selection. In one embodiment, the specific real estate asset selection can be performed online using a map, such as interactive map. In some embodiments, a potential buyer can input their valid PIN and be prompted by the asset reservation module 332 to make a real estate asset selection from a map schematically depicting a real-time availability status of each real estate asset. For example, the map may include visual and/or audio indications of which real estate assets are available for reservation and which assets have already been reserved. In some embodiments, the reservation deposit can be applied to the purchase price of the specific real estate asset. After receiving a specific real estate reservation request in block 526, the routine 500 can end 524. In another embodiment, the potential buyer may select a specific real estate asset via telephone or in-person. In this embodiment, the routine 500 can end 524 following blocks 516 or 518.

FIG. 5B is flow diagram of a routine 501 for providing notification to a potential buyer of an opportunity to reserve a specific real estate asset in accordance with an embodiment of the disclosure. The routine 501 begins 528 following block 518 in routine 500. The asset reservation module 332 provides notification to the potential buyer when the real-time priority number is higher than all other priority numbers for the real estate interest list (block 530). Following notification in block 530, the routine 501 returns 532 to decision block 520 in routine 500 (FIG. 5A). Also, following block 530, the routine 501 continues in block 534 wherein the asset reservation module 332 notifies a second potential buyer having a second highest real-time priority number after an elapsed period of time from the notification to the potential buyer in block 530. Following notification in block 534, the routine 501 returns 532 to decision block 520 in routine 500 (FIG. 5A).

In one embodiment, the elapsed period of time can be approximately 1 minute to several days (e.g., about 1 day to about 10 days). In another embodiment, the second potential buyer with the second highest real-time priority number can be notified (block 534) after the potential buyer has finalized a selection enabled by the notification. One of ordinary skill in the art will recognize additional time periods and time delays to separate blocks 530 and 534.

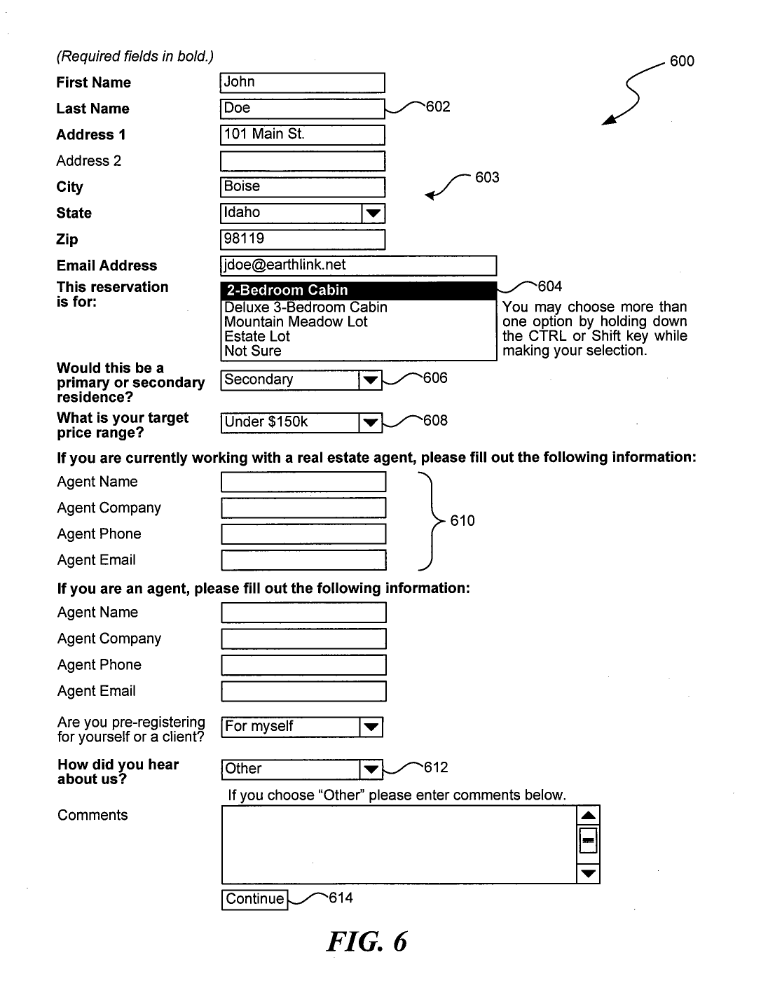

FIG. 6 is a schematic diagram of a screen display 600 configured in accordance with an embodiment of the disclosure. In one aspect of this embodiment, the screen display 600 can be presented to a potential buyer wishing to reserve a real-time priority number on an interest list, such as a real estate interest list. The screen display 600 includes a plurality of data entry fields and/or other portions whereby the potential buyer can enter information about himself or herself (e.g., identification information, etc.) and/or about the particular reservation he or she wishes to obtain. For example, the screen display 600 can include a plurality of data entry fields configured to receive information about the potential buyer, such as a name portion 602 in which the potential buyer can provide his or her name. The screen display 600 can also include other fields 603 for obtaining potential buyer information such as a current street address field, current email address field, current day and nighttime telephone number fields, etc.

After the potential buyer has input the required information, he or she can enter additional information relating to specific aspects of their interest. In one embodiment, the interest list can be for future releases of real estate assets. The additional data entry fields on the screen display 600 can include a drop-down selection field 604 for selecting a particular type of real estate asset, if known. Additional data entry fields can also include selection of type of residence 606, target price range 608, real estate agent name and contact information 610, etc. Other information desirable for future marketing of the assets can include source information 612 pertaining to how the potential buyer heard of the reservation list or the assets. One of ordinary skill in the art will recognize additional data fields adapted to receive information from a potential buyer. Additionally, one of ordinary skill in the art will recognize that the information input into the data entry fields can be populated into a database of information for use with monitoring and managing the reservation interest list and/or for other marketing studies and purposes. For example, the information may be packaged and sold to marketing and/or distribution entities. Upon completion of identity information entry, the potential buyer may continue in the reservation request process by selecting a “Continue” option 614 or the like.

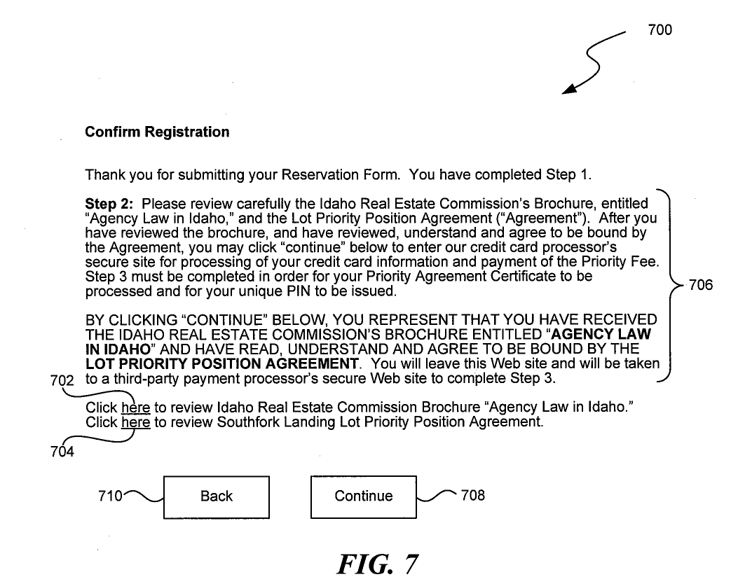

FIG. 7 is a schematic diagram of a display page 700 that includes information relating to confirming registration in accordance with an embodiment of the disclosure. Further, this display page can, in some embodiments, include links 702 and 703 which the user can select to review additional information relating to, e.g., Agency Law and, e.g., a Reservation Agreement, respectively. For example by initiating the link 702, an additional display page(s) pertaining to Agency Law can be accessed by the potential buyer.

Referring to FIG. 7, by initiating the link 704, additional display pages pertaining to a reservation agreement (e.g., a lot priority position reservation agreement or other legal agreement) can be accessed and navigated via display pages by the potential buyer. In another embodiment, additional documents accessed via links 702 and 704, for example, can be downloaded for saving to a hard drive, printed, etc. The reservation agreement may contain one or more terms and conditions of the priority reservation provided during the reservation process.

FIG. 7 can also provide information 706 regarding the acknowledgement and acceptance of the terms and conditions specified by the reservation agreement 900. For example, a potential buyer may be informed that by selecting a “Continue” option 708 on the display page 700, the potential buyer is agreeing the stated terms and conditions. In the event that a potential buyer is not prepared to move forward with the priority reservation process, the display page 700 can also provide such a user a “Back” option 710 or other type of decline option.

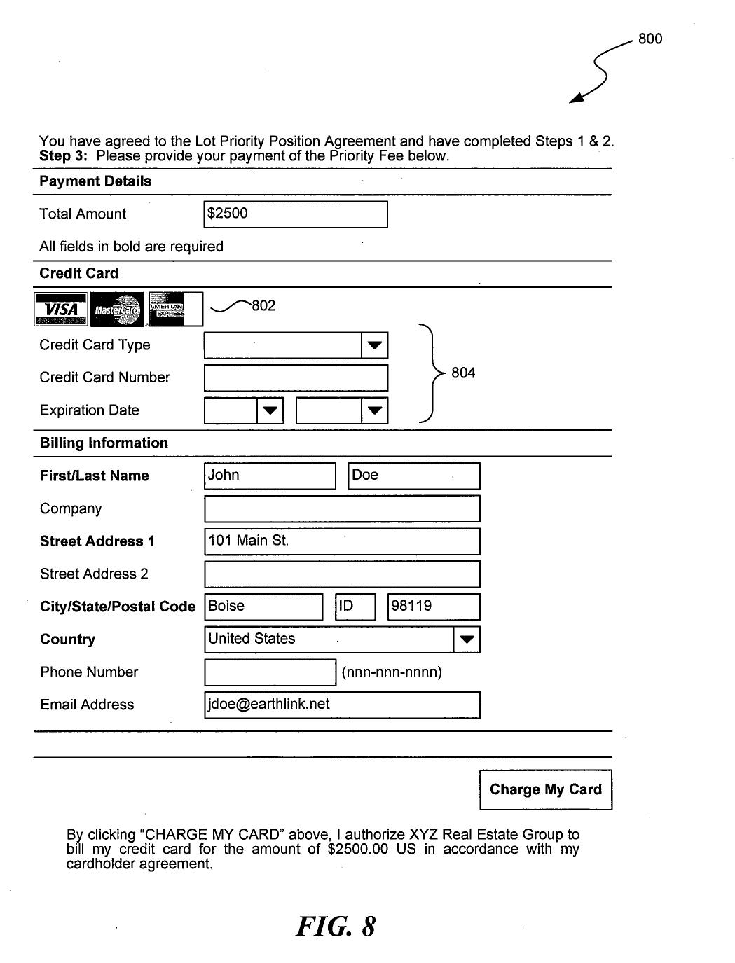

Upon selecting the “Continue” option 708 on display page 700, the potential buyer may be required to provide a deposit fee (e.g., a Priority Fee, etc.) for securing their priority reservation. FIG. 8 illustrates a payment display page 800 whereby the potential buyer can provide payment information in accordance with an embodiment of the disclosure. For example, data entry fields on display page 800 can include a selection of payment method 802 (e.g., credit card, debit card, automatic bank transfer, etc.), specific account access information 804, permission to debit the buyer-owned financial account 1006, and other related billing information.

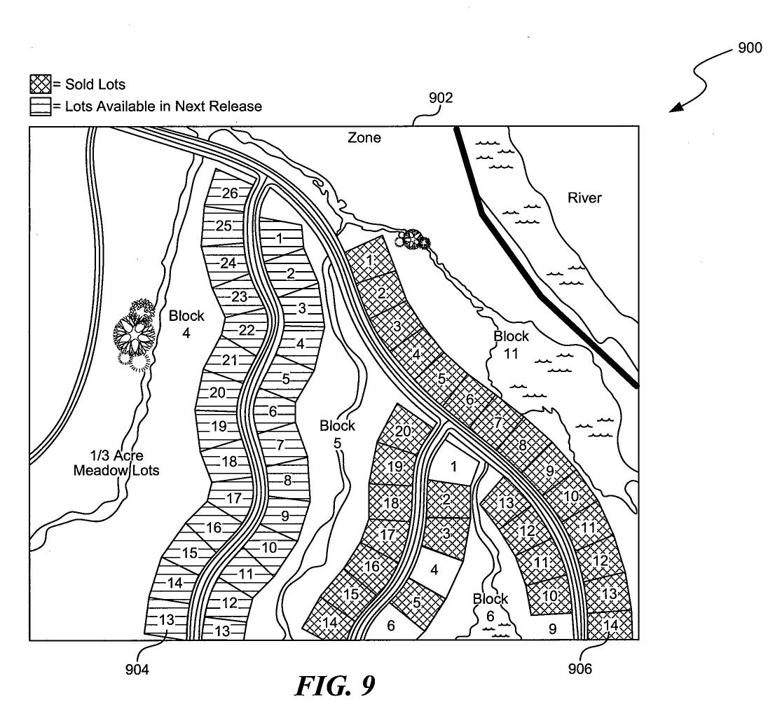

FIG. 9 is a schematic diagram of a display page 900 having an interactive map 902 for selecting and reserving a specific real estate asset (e.g., real estate lot sites, condominiums, etc.) in accordance with an embodiment of the disclosure. For example, a potential buyer having a priority registration may access the display page 900 for viewing the map 902. The map 902 can include illustrative representation of real estate assets 904 to be sold as well the assets' real-time availability status. For example, if a real estate asset 906 is not available for reservation and/or purchase, the asset 906 may be illustrated in an alternate color. In another embodiment, once the potential buyer makes a selection and indicates a specific real estate asset 904 to reserve for purchase, the availability status of the selected real estate asset 904 can be changed in real-time from “AVAILABLE” to “RESERVED”. Accordingly, a subsequent potential buyer, when prompted to make a specific real estate asset reservation selection, will be prevented from selecting any previous potential buyer's selected real estate assets.

In general, the detailed description of embodiments of the disclosure is not intended to be exhaustive or to limit the disclosure to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the disclosure may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the disclosure may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the disclosure reside on a server computer, while corresponding portions reside on a client computer such as a mobile or portable device, and thus, while certain hardware platforms are described herein, aspects of the disclosure are equally applicable to nodes on a network.

The teachings of the disclosure provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description details certain embodiments of the disclosure and describes the best mode contemplated, no matter how detailed the above appears in text, the disclosure can be practiced in many ways. Details of the disclosure may vary considerably in its implementation details, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following examples should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure.

I/We claim:

1. A system for providing priority reservations comprising:
a server;
a client computer;
a computer network connected to the server and the client computer for transmitting reservation requests and data, payment processing commands, and priority number requests; and
a reservation generator comprising,
a priority reservation module configured to receive a reservation request from the client computer for reserving a next available priority number on an interest list;
a reservation account activation module configured to create a reservation account and receive funds in the reservation account; and
a priority number module configured to send an interest list priority number to the potential buyer.

2. The system of claim 1, further comprising a PIN management module configured to link a unique personal identification number (PIN) to a potential buyer, and wherein the priority number module is configured to make available the interest list priority number responsive to receipt of a valid PIN.

3. The system of claim 1, further comprising a database for storing reservation related data.

4. The system of claim 1 wherein the reservation generating unit resides on a server.

5. The system of claim 1 wherein the reservation generator further comprises a deposit funding module configured to:
receive information for a buyer-owned financial account and receive permission from the client computer to debit the buyer-owned financial account; and
communicate with a financial service institution processor, wherein the communication includes requesting a transfer of funds from the buyer-owned account to the reservation account.

6. The system of claim 1 wherein the reservation generator further comprises a refund module configured to refund at least a portion of the funds in the reservation account upon an interest list removal request received from the client computer.

7. The system of claim 1 wherein the reservation generator further comprises an asset reservation module configured to activate the PIN-responsive priority number and to receive a request from the client computer to reserve a specific asset selected from one or more available assets.

8. A computer-implemented method for performing a reservation, the method comprising:
providing a reservation page, wherein the reservation page is accessible to a potential buyer;
receiving identification information from the potential buyer;
receiving a reservation request from the potential buyer for reserving a real-time priority number on an interest list;
linking a unique personal identification number (PIN) to the identification information;
providing the potential buyer with the PIN; and
providing the real-time priority number responsive to receiving a real-time priority request, wherein the real-time priority request comprises the PIN.

9. The method of claim 8 wherein before providing the potential buyer with the PIN, the method further comprises:
receiving information for a buyer-owned financial account and receiving permission from the potential buyer to debit the buyer-owned financial account; and
communicating with a financial service institution processor, wherein the communication includes requesting a transfer of funds from the buyer-owned account to a reservation account.

10. The method of claim 9 wherein before receiving information for a buyer-owned financial account, the method further comprises:
providing terms and conditions of a reservation agreement; and
receiving a potential buyer's agreement to the terms and conditions of the agreement.

11. The method of claim 8, further comprising providing a notification to the potential buyer when the real-time priority number is higher than all other priority numbers for the interest list.

12. The method of claim 11 wherein a second potential buyer with a second highest real-time priority number is notified after an elapsed period of time from the notification to the potential buyer.

13. The method of claim 12 wherein the elapsed period of time is about 24 hours.

14. The method of claim 12 wherein the elapsed period of time is about two days.

15. The method of claim 11 wherein a second potential buyer with a second highest real-time priority number is notified after the potential buyer has finalized a selection enabled by the notification.

16. The method of claim 8 wherein the reservation is a real estate reservation.

17. A computer-implemented method for performing a real estate reservation, the method comprising:
providing a real estate reservation page, wherein the reservation page is accessible to a potential buyer;
receiving identification information from the potential buyer;
receiving a reservation request from the potential buyer for reserving a real-time priority number on a real estate interest list;
receiving information for a buyer-owned financial account and receiving permission from the potential buyer to debit the buyer-owned financial account;
communicating with a financial service institution processor, wherein the communication includes requesting a transfer of funds from the buyer-owned financial account to a real estate reservation account; and
providing the real-time priority number to the potential buyer.

18. The method of claim 17, further comprising:
linking a unique personal identification number (PIN) to the identification information and the real estate reservation account;
providing the potential buyer with the PIN upon receiving the transfer of funds to the real estate reservation account; and
wherein the providing the real-time priority number to the potential buyer includes providing the real-time priority number responsive to receiving a real-time priority request, wherein the real-time priority request comprises the PIN.

19. The method of claim 17, further comprising receiving real estate preference information from the potential buyer.

20. The method of claim 17 wherein the real estate reservation page includes reservation instructions.

21. The method of claim 17 wherein before receiving information for a buyer-owned financial account, the method further comprises:
providing terms and conditions of a real estate reservation agreement; and
receiving a potential buyer's agreement to the terms and conditions of the agreement.

22. The method of claim 17 wherein the potential buyer is a first potential buyer, and wherein the real-time priority number provided in response to receiving a real-time priority request changes in response to removal of a second potential buyer from the interest list when the second potential buyer has a higher priority number than the first potential buyer.

23. The method of claim 17, further comprising providing a notification to the potential buyer when the real-time priority number is higher than all other priority numbers for the interest list.

24. The method of claim 17 wherein a second potential buyer with a second highest real-time priority number is notified after an elapsed period of time from the notification to the potential buyer.

25. The method of claim 23 wherein after providing a notification, the method further includes providing to the potential buyer one or more real estate assets available to reserve and receiving a request from the potential buyer to reserve a specific real estate asset, the request including the PIN, wherein the one or more real estate assets are illustrated on the real estate reservation page in an interactive map, and wherein receiving a request from the potential buyer includes selecting one asset on the map.

26. The method of claim 25 wherein each of the one or more illustrated assets include availability status of the asset on the interactive map, and wherein selecting the asset on the map includes changing the availability status from an available status to a reserved status.

27. The method of claim 17, further comprising refunding at least a portion of the funds in the real estate reservation account upon removal of the potential buyer from the real estate interest list.

28. A computer-readable medium whose contents cause at least one computer to perform a method for providing a priority registration, the method comprising:
providing a reservation page, wherein the reservation page is accessible to a potential buyer;
receiving a reservation request from the potential buyer for reserving a real time priority number on an interest list, wherein the reservation request includes potential buyer identification information;
in response to the request, creating a reservation account and linking the reservation account to a unique personal identification number (PIN);
transferring funds from a buyer-owned funding source to the reservation account;
providing the potential buyer with the PIN upon receiving the transfer of funds to the reservation account; and
providing the real-time priority number responsive to receiving a real-time priority request, wherein the real-time priority request comprises the PIN.

29. The method of claim 28 wherein before transferring funds from a buyer-owned funding source to the reservation account, the method further comprises:
providing terms and conditions of a reservation agreement; and
receiving a potential buyer's agreement to the terms and conditions of the agreement.

30. The method of claim 28, further comprising providing a notification to the potential buyer when the real-time priority number is higher than all other priority numbers for the interest list.

31. The method of claim 28 wherein a second potential buyer with a second highest real-time priority number is notified after an elapsed period of time from the notification to the potential buyer.

32. The method of claim 28 wherein the reservation is a real estate reservation.
